(19) United States
(12) Patent Application Publication
(10) Pub. No.: US 2006/0172100 A1
(43) Pub. Date: Aug. 3, 2006

(54) Metal plate coated with polyester resin, and can using the same

(75) Inventors: Lianchun Hu, Yamaguchi-ken (JP); Narimasa Maida, Yamaguchi-ken (JP); Satoshi Takahashi, Yamaguchi-ken (JP); Hiroshi Kurisu, Yamaguchi-ken (JP)

Correspondence Address: BROWDY AND NEIMARK, P.L.L.C.;624 NINTH STREET, NW, SUITE 300, WASHINGTON, DC, 20001-5303, US

(73) Assignee: Toyo Kohan Co. Ltd., Chiyoda-ku (JP)

(21) Appl. No.: 11/113,333

(22) Filed: Apr. 25, 2005

(30) Foreign Application Priority Data
Feb. 2, 2005 (EP) 05 002160.9

(51) Int. Cl. B32B 15/08; B32B 27/36; B32B 15/09

(52) U.S. Cl. 428/35.8; 428/458; 428/480

(57) ABSTRACT

The present invention intends to provide a metal plate coated with polyester resin which does not generate cracks and fractures and is excellent in moldability and corrosion resistance when being applied by a severe molding processing, and to provide a can using the same which is excellent in preservation of flavoring properties for content. For this purpose, the metal plate, which the surface roughness Ra (JIS B 0601) is 1 μm or less, coated with polyester resin of the present invention employs a polyester resin having an intrinsic viscosity of 0.6 to 1.4 and being non-oriented.

### DETAILED DESCRIPTION OF THE INVENTION

1. Technical Field

The present invention relates to a metal plate coated on the both sides thereof with non-oriented polyester resin and a can using the same. In more detail, the present invention relates to a metal plate coated with polyester resin which is excellent in moldability, corrosion resistance and preservation of flavoring properties of content (flavor sustainability), especially applicable to beverage cans, and a can using the same by applying deep drawing processing or drawing ironing processing.

2. Background Art

In these days, cans are used, especially for beverage can usage, which are manufactured with a metal plate coated with a biaxially-stretched oriented polyester resin film by employing severe molding processing such as wall-thinning deep drawing processing with high contraction ratio and high reducing ratio in the thickness of side wall of can, and the like processing. When this metal plate coated with a biaxial-stretched oriented polyester resin film is molded by the wall-thinning deep drawing processing, because the resin film coated on the surface of a metal plate can not enough subject to the large deformation in processing, fine cracks generated in the film result in deterioration of corrosion resistance, or the shell of can is broken by the film fracture caused in can molding, and further processing becomes impossible; therefore, further cost reduction by enhancing contraction ratio and thickness reducing ratio is extremely difficult. Although the moldability is improved by reducing biaxial orientation of the polyester film or making it non-oriented, resin cystallinity is reduced, resulting in decrease of permeability resistance of the resin film against water or oxygen and deterioration of corrosion resistance and preservation of flavoring properties of content when the can containing contents is retained for long time.

The present invention intends to provide a metal plate coated with polyester resin which is free from crack generation or fracture under severe molding processing such as wall-thinning deep drawing, and is excellent in moldability and corrosion resistance, and a can using the same which is superior in preservation of flavoring properties of the content.

### DISCLOSURE OF THE INVENTION

A metal plate, wherein the surface roughness Ra (JIS B 0601) is 1 μm or less, coated with polyester resin is characterized by being coated on both sides of the metal plate with a non-oriented polyester resin having an intrinsic viscosity of 0.6 to 1.4.

In the coated metal plate, the metal plate is preferably coated on at least one side thereof with a transparent polyester resin without containing a pigment.

The metal plate coated with polyester resin of the invention is characterized in that the transparent polyester resin includes a two-layer resin of a lower resin layer contacting the metal plate and a upper resin layer coated on the lower layer, wherein a melting temperature of the upper layer resin is higher than that of the lower layer resin.

In the metal plate coated with polyester resin, the metal plate is preferably coated on at least one side thereof with a colored polyester resin containing a pigment.

The metal plate coated with polyester resin of the invention is characterized in that the colored polyester resin contains a pigment of 15 to 40% by weight.

The metal plate coated with polyester resin of the invention is characterized in that the colored polyester resin includes a three-layer resin of a lower resin layer contacting the metal plate, a core resin layer coated on the lower layer and a upper resin layer further coated on the core layer, wherein each of melting temperatures of the upper layer resin and the core layer resin is higher than a melting temperature of lower layer resin.

In the metal plate coated with polyester resin, the core layer in the three-layer resin has preferably 90 to 100% of an amount of the pigment contained in whole of the three-layer resin.

In the metal plate coated with polyester resin, the pigment is preferably a titanium dioxide.

In the coated metal plate, the metal plate is preferably any of a tinned steel plate, a tin-free steel plate or an aluminum alloy plate.

A can of the invention is characterized by using the metal plate coated with polyester resin.

### BEST MODE FOR CARRYING OUT THE INVENTION

The present invention is a metal plate coated with polyester resin in which a non-oriented polyester resin having an intrinsic viscosity of 0.6 to 1.4 is coated on both sides of the metal plate; this metal plate of the invention does not cause crack generation or fracture in the resin under severe molding processing such as wall-thinning deep drawing, and exhibits excellence in moldability and corrosion resistance. A can using the metal plate coated with polyester resin of the invention is superior in preservation of flavoring properties of contents.

The present invention is explained in detail as follows.

The polyester resin applied to the present invention is explained. The polyester resin is preferably a polyester resin containing any one or more kind of ester unit such as an ethylene terephthalate, a butylene terephthalate, a 1,4-cyclohexanedimethyl terephthalate, an ethylene isophthalate, a butylene isophthalate, an ethylene adipate, a butylene adipate, an ethylene naphthalate and a butylene naphthalate. The polyester resin is preferably a polyester resin obtained by polycondensation of one or more kind of those ester monomers, or a polyester resin blended with two or more kinds of polyester resins thereof. A polyester resin, other than those described above, may be used; the polyester resin which uses a sebacic acid, a trimellitic acid and the like as an acid component of the ester unit thereof; or which uses a propylene glycol, a diethylene glycol, neopentyl glycol, a pentaethythritol and the like as an alcohol component of the ester unit thereof.

The polyester resin used for the present invention must be reinforced by increasing an intrinsic viscosity thereof, in order to apply severe molding processing such as wall-thinning deep drawing without causing cracks, fracture, scar and peeling in the resin, and to use the resin in non-oriented state which is superior in moldability. For this purpose, the intrinsic viscosity of the polyester resin is preferably in the range of from 0.6 to 1.4, more preferably from 0.8 to 1.2. When a polyester resin having an intrinsic viscosity of less than 0.6 is used, the strength of the resin is extremely decreased and such resin can not be employed to a wall-thinning deep drawing can intended by the present invention; and the preservation of flavoring properties of content is also degraded, it is not preferable. On the other hand, when the intrinsic viscosity of the resin exceeds 1.4, the melt viscosity of the resin molten by heat is significantly increased, resulting in that the work to coating the polyester resin on a metal plate becomes extremely difficult.

Furthermore, the metal plate coated with polyester resin of the invention is preferably coated with a pigment-free, transparent and colorless polyester resin on at least one side of the metal plate which becomes the inside of a can after being molded to the can. This transparent polyester resin may be a monolayer or a multilayer including at least two layers of upper layer and lower layer, those of which apply plural kind of resins having respectively different properties. In the case of the monolayer, a high crystalline polyester resin having a half crystallization time of less than 50 seconds is not preferable to be used, because the resin is poor in adhesibility with a metal plate and tends to peel off or generate fractures or fine cracks in the resin when the metal plate is subjected to a severe processing such as a wall-thinning deep drawing processing. In the case of the two-layer resin, the lower layer resin contacting the metal plate is preferably a resin whose melting temperature is lower than that of the upper layer resin, more preferably by 5° C. or more, and whose half crystallization time is 50 seconds or more and longer than that of the upper layer resin, that is, a resin being hardly crystallized.

The melting temperature of the present invention represents a temperature exhibiting maximum depth in the heat absorption peak when a resin is heated at a heating rate of 10° C./minute with a differential scanning calorimetry (DSC). The half crystallization time of the invention is defined as follows; when a resin is heated to melt with DSC, followed by quenching to be made amorphous, then again heated to a certain temperature within its crystallizing temperature range and held for a certain time to be crystallized; a curve is drawn by consecutively measuring absorbed heat amount after the holding commenced. The interval from the commencement of the holding to the time appearing a bottom part in the heat absorption peak after a certain period of time elapsed is defined as the half crystallization time.

Cans, which are molded from a metal plate coated with non-oriented polyester by processed with a severe molding processing, are subjected to a heat treatment to release a stress in the resin generated during molding process and to crystallize the resin to improve corrosion resistance. When the heat treatment temperature is too low, crystallization does not proceed sufficiently and therefore improvement of corrosion resistance is not achieved. When the heat treatment temperature is too high, the crystal grows brittle and coarse, resulting in deterioration of impact resistance. Therefore, the heat treatment temperature range satisfying both of corrosion resistance and impact resistance is so narrow that controlling the temperature range is significantly difficult. When applying the two-layer resin for the polyester resin coated on a metal plate, the two-layer which includes, as mentioned above, a lower layer contacting the metal plate employing a polyester resin having low melting temperature and being hardly crystallized, and a upper layer employing a polyester resin having high melting temperature and being easily crystallized; a can processed by molding can be treated by heat in the broad temperature range.

A thickness of the colorless and transparent polyester resin is preferably 5 to 60 μm, more preferably 10 to 40 μm. If the thickness is less than 5 μm, the work coating the resin on a metal plate becomes significantly difficult, and the resin layer applied by the wall-thinning deep drawing tends to cause defects and is not sufficient in its permeability resistance. On the other hand, although increasing thickness is advantageous for permeability resistance, the thickness of 60 μm or more is economically disadvantage. When the resin having two layers of the upper and the lower is coated, the thickness of upper resin layer is preferably 2 to 30 μm, and that of lower resin layer is preferably 3 to 58 μm. If the thickness of upper resin layer is extremely thin, the permeability resistance and preservation of flavoring properties may become not sufficient depending on the kind of content contained; on the other hand, if the thickness of lower resin layer is extremely thin, the adhesion ability in processing becomes not sufficient. In the resin, as long as not impairing the properties thereof, stabilizers, antioxidation agents and lubricants such as silica may be added.

Furthermore, the metal plate coated with polyester resin of the present invention is preferably coated with a colored polyester on at least one side of the metal plate which becomes outside of the can when the metal plate is molded; pigments coloring the polyester resin include a white inorganic pigment such as a rutile type or anatase type titanium dioxide, a zinc flower, a gloss white, a sedimentary sulfuric acid treated perlite, a calcium carbonate, a plaster, a sedimentary silica, an aerosil, a talc, a calcined or non-calcined clay, a barium carbonate, an alumina white, a synthetic or unsynthetic mica, a synthesized calcium silicate, and a magnesium carbonate; a black inorganic pigment such as a carbon black and a magnetite; a red inorganic pigment such as a Bengal red and a red lead; a blue inorganic pigment such as a ultramarine blue and a cobalt blue; a yellow inorganic pigment such as a lead yellow and a zinc yellow; and organic pigments having various colors, preferably a white titanium dioxide. The colored polyester resin may be, as well as the transparent polyester resin described above, a monolayer resin or a multilayer resin such as a three-layer resin including an upper layer, a lower layer and a core layer interposed between them, those of which apply plural kind of resins having respectively different properties. In the case of the multilayer resin, as well as the transparent polyester resin described above, the lower layer resin contacting the metal plate is preferably a resin whose melting temperature is lower than that of the resins of any of layers layered thereon, more preferably by 5° C. or more, and whose half crystallization time is 50 seconds or more and longer than that of the resins of any of layers layered thereon, that is, a resin hardly crystallized is preferable.

When the colored polyester resin includes three layer of a lower layer resin contacting the metal plate, a core layer layered thereon and an upper layer resin further layered thereon, each melting temperature of the upper layer resin and the lower layer resin is higher than that of the lower layer resin, preferably by 5° C. or more, and the half crystallization time is preferably shorter them that of the lower layer resin, that is the resin easily crystallized is preferable.

A thickness of the colored polyester resin described above is preferably 5 to 50 μm, more preferably 10 to 40 μm. If the thickness is less than 10 μm, the resin can not sufficiently hide the color of substrate metal plate due to too small amount of pigment contained in the resin. Moreover, the work coating the resin on a metal plate becomes significantly difficult, and the resin layer applied by the wall-thinning deep drawing tends to cause defects. On the other hand, although increasing thickness is advantageous for sufficiently hiding the substrate and for coating workability, the thickness of 50 μm or more is economically disadvantage.

The colored polyester resin preferably contains a pigment of 15 to 40% by weight. If the amount contained is 15% by weight or less, the color of the substrate metal plate is not fully hidden. On the other hand, if the amount contained is 40% by weight or more, adhesivility and moldability of the resin are deteriorated so that the resin tend to cause peelings, fractures and scars in being processed to a can.

When the colored resin is a three-layer resin, the resin thickness of the upper layer and lower layers is preferably 1 to 15 μm and the resin thickness of the core layer is preferably 3 to 48 μm. In the case of three-layer resin, the amount of pigments contained in whole layer is preferably distributed in the core layer in an amount of 90 to 100%, and the amount distributed in both of the upper and lower layers is preferably less than 10%. Making the amount of pigments contained in the upper and lower layers small allows to prevent resins from peelings, fractures and scars caused in processing a can, and to decrease the wearing of processing tool due to hard pigment particles contained in the upper layer. In the three-layer resin, if the resin thickness of the lower layer is extremely thin, the adhesion ability in processing becomes not sufficient, and if the resin thickness of the upper layer is extremely thin, the moldability becomes poor.

In the above described resin, as long as not impairing the properties thereof, stabilizers, antioxidation agents and lubricant such as silica may be added.

The metal plate as a substrate of the metal plate coated with polyester resin of the present invention may employ various surface treated steel sheets such as a tinned steel plate usually widely used as a material for can and a electrolytic chromium coated steel (tin-free steel plate, referred to as TFS hereinafter) and the like, and an aluminum alloy plate. The surface roughness Ra (JIS B 0601) of the metal plate is preferably 1.0 μm or less, more preferably 0.5 μm or less. If the surface roughness Ra is exceeding 1.0 μm, a lot of bubbles exist between the polyester resin and the meatl plate after laminating with the polyester resin. The polyester resin is cut down or the can body is broken when being applied by a severe molding processing such as wall-thinning deep drawing. As the surface treated steel sheets, preferable is a tin-free steel plate in which two-layer coating is formed on the surface of a steel, the two-layer coating which includes a lower layer having metal chromium coating value of 10 to 200 mg/m² and a upper layer having hydrous chromium oxide coating value of 1 to 30 mg/m² in terms of chromium; and this plate has sufficient adhesion ability with the polyester resin of the present invention along with corrosion resistance. As the tinned-steel plate, preferable is a steel sheet on which tin is plated in the plated amount of 0.1 to 11.2 mg/m² and has a two-layer coating formed on the tin plating; the two-layer coating which includes metal chromium and hydrous chromium oxide in the coating value of 1 to 30 mg/m² in terms of chromium; or the mono-layer coating which consists only of hydrous chromium oxide. In any cases, the steel sheet to be the substrate is preferably a low carbon cold rolled steel sheet which is generally used for the material for cans. The thickness of the steel sheet is preferably 0.1 to 0.32 mm. An aluminum alloy plate is preferably those defined in JIS-3000 or -5000 series; more preferably the one on which surface two-coating layer is formed by electrolytic chromium acid treatment, the two-coating layer which includes a lower layer having metal chromium coating value of 0 to 200 mg/m² and a upper layer having hydrous chromium oxide coating value of 1 to 30 mg/m² in terms of chromium; or the another on which surface chromium and phosphorous components are adhered by phosphoric acid chromate coating treatment in the amount of 1 to 30 mg/m² in terms of chromium and the amount of 0 to 30 mg/m² in terms of phosphorous. The thickness of the aluminum alloy plate is preferably 0.15 to 0.4 mm.

The method to coat the polyester resin of the present invention on the metal plate can apply any of known film laminating methods or extrusion laminating methods.

When coating by the film laminating methods, resin pellets are heated to melt at a temperature of 20 to 40° C. higher than the melting temperature thereof, cast from a T-die on a cooled casting roll, and then rewound by a coiler without elongating to produce non-oriented resin film. On the other hand, the metal plate wound as a long sheet is unwound from an uncioler along with the unwound sheet being heated to a temperature of 20 to 40° C. higher than the melting temperature of the resin, the heated metal plate being subjected to contact with the non-oriented resin film which being unwound, and then both of them being pressed by a pair of lamination rolls to adhere each other, followed by immediately quenching in water. When coating by the extrusion laminating methods, resin pellets are heated to melt at a temperature of 20 to 40° C. higher than the melting temperature thereof, cast from a T-die directly on the long-sheet metal plate which is unwound from an uncioler, followed by immediately quenching in water.

Adhesives may be interposed between the polyester resin and the metal plate for laminating. This lamination method is applied for a tinned steel plate or the like in which the temperature of metal plate can not be raised so high because the plating layer of the metal plate melts in the film laminating methods. The kinds of adhesives used for the present invention is not particularly limited, preferably used are epoxy/phenol adhesives, epoxy/urea adhesives, urethane adhesives and the like.

### EXAMPLE

The present invention is explained in detail according to the Examples.

The polyester resin exhibited in Table 1 which was coated on the one side and the other side of the metal plate having the surface roughness Ra as shown in Table 1, and the polyester resin containing pigment in the amount exhibited in Table 2 (referred to as a white resin hereinafter) were heated to melt and mix by a biaxial extruder at the temperature of about 30° C. higher than the melting temperatures (Tm) of respective resins, sent to a T-die having nozzle width of 1000 mm (in case of two- or three-layer resin, a T-die capable co-extruding two or three layers) to extrude out from the die nozzles and then trimmed as a film of 800 mm width to be wound as the non-oriented film. PET in Table 1 is the polyethylene terephthalate and PETI is the polyester copolymer resin of ethylene terephthalate and ethylene isophthalate. The polyester resin used as the lower layer of the transparent resin and the lower layer of the white resin exhibited in Sample number 17 was the blended resin of PETI 10% by mole (67% by weight) and PETI 25% by mole (33% by weight).

TABLE 1
Specification of metal palte and polyester resin at the inside of the can

| | | | Polyester Resin at the Inside of the Can | | | | | | | | | | |
|---|---|---|---|---|---|---|---|---|---|---|---|---|---|
| | Metal Plate | | Upper Layer | | | | | Lower Layer | | | | | |
| | | Surface | | | | Half | | | | | Half | | |
| | | rough- | Composition | | Melting | Crystall- | | Composition | | Melting | Crystall- | | |
| Sam- | Surface | ness | (mole % of | Intrinsic | temper- | ization | Thick- | (mole % of | Intrinsic | temper- | ization | Thick- | |
| ple | treat- | (Ra, | isophthalic | Vis- | erature | Time | ness | isophthalic | Vis- | ature | Time | ness | Class- |
| No | ment | μm) | acid) | cosity | (° C.) | (sec.) | (μm) | acid) | cosity | (° C.) | (sec.) | (μm) | ification |
| 1 | Tin | 0.3 | PETI-12 | 0.5 | 226 | 45 | 25 | — | — | — | — | — | Comparative |
| | plate | | | | | | | | | | | | Example |
| 2 | Tin | 0.3 | PETI-12 | 0.8 | 226 | 58 | 25 | — | — | — | — | — | Present |
| | plate | | | | | | | | | | | | Invention |
| 3 | Tin | 0.3 | PETI-10 | 1.0 | 230 | 63 | 25 | — | — | — | — | — | Present |
| | plate | | | | | | | | | | | | Invention |
| 4 | Tin | 0.3 | PETI-12 | 1.2 | 226 | 65 | 25 | — | — | — | — | — | Present |
| | plate | | | | | | | | | | | | Invention |
| 5 | Tin | 0.3 | PETI-12 | 1.4 | 226 | 70 | 25 | — | — | — | — | — | Present |
| | plate | | | | | | | | | | | | Invention |
| 6 | Tin | 0.3 | PETI-12 | 0.8 | 226 | 58 | 25 | — | — | — | — | — | Comparative |
| | plate | | | | | | | | | | | | Example |
| 7 | TFS | 0.2 | PETI-10 | 0.8 | 229 | 49 | 2 | PETI-25 | 1.0 | — | Amor- | 3 | Present |
| | | | | | | | | | | | phous | | Invention |
| 8 | TFS | 0.2 | PETI-10 | 0.8 | 229 | 49 | 2 | PETI-20 | 1.0 | 210 | 182 | 58 | Present |
| | | | | | | | | | | | | | Invention |
| 9 | TFS | 0.2 | PETI-10 | 0.8 | 229 | 49 | 10 | PETI-15 | 1.0 | 220 | 138 | 15 | Present |
| | | | | | | | | | | | | | Invention |
| 10 | TFS | 0.2 | PETI-10 | 1.0 | 230 | 63 | 20 | PETI-12 | 1.0 | 226 | 65 | 5 | Present |
| | | | | | | | | | | | | | Invention |
| 11 | TFS | 0.2 | PETI-5 | 0.8 | 240 | 14 | 30 | PETI-12 | 1.0 | 226 | 55 | 20 | Present |
| | | | | | | | | | | | | | Invention |
| 12 | TFS | 0.2 | PETI-5 | 1.0 | 240 | 27 | 30 | PETI-12 | 1.0 | 226 | 65 | 20 | Comparative |
| | | | | | | | | | | | | | Example |
| 13 | TFS | 0.2 | PETI-10 | 1.0 | 230 | 58 | 6 | PETI-15 | 1.0 | 220 | 138 | 15 | Present |
| | | | | | | | | | | | | | Invention |
| 14 | TFS | 0.2 | PETI-5 | 1.0 | 240 | 27 | 6 | PETI-15 | 1.0 | 220 | 138 | 25 | Present |
| | | | | | | | | | | | | | Invention |
| 15 | TFS | 0.2 | PETI-5 | 1.0 | 240 | 27 | 4 | PETI-15 | 1.0 | 220 | 138 | 25 | Present |
| | | | | | | | | | | | | | Invention |
| 16 | TFS | 0.2 | PETI-10 | 1.0 | 230 | 63 | 4 | PETI-15 | 1.0 | 220 | 138 | 16 | Present |
| | | | | | | | | | | | | | Invention |
| 17 | Alum- | 0.3 | PETI-12 | 0.8 | 226 | 58 | 5 | PETI-10 | 0.8 | 220 | 70 | 16 | Present |
| | inum | | | | | | | (67 W %) | | (after blended) | | | Invention |
| | Alloy | | | | | | | PETI-25 | 1.0 | | | | |
| | Sheet | | | | | | | (33 W %) | | | | | |
| 18 | TFS | 1.2 | PETI-10 | 1.0 | 230 | 63 | 20 | PETI-15 | 1.0 | 220 | 138 | 15 | Comparative |
| | | | | | | | | | | | | | Example |

TABLE 2
Specification of metal palte and polyester resin at the outside of the can

| | Polyester Resin at the Outside of the Can | | | | | | | | | | | |
|---|---|---|---|---|---|---|---|---|---|---|---|---|
| | Upper Layer | | | | | | Core Layer | | | | | |
| | Composition | | Melting | Half | | | Composition | | Melting | Half | | |
| | (mole % of | | temper- | Crystallization | TiO₂/ | Thick- | (mole % of | | temper- | Crystallization | TiO₂/ | |
| Sample | isophthalic | Intrinsic | ature | Time | Layer | ness | isophthalic | Intrinsic | ature | Time | Layer | Thickness |
| No | acid) | Viscosity | (° C.) | (sec.) | (%) | (μm) | acid) | Viscosity | (° C.) | (sec.) | (%) | (μm) |
| 1 | PETI-12 | 0.5 | 226 | 45 | 100 | 15 | — | — | — | — | — | — |
| 2 | PETI-12 | 0.8 | 226 | 58 | 100 | 15 | — | — | — | — | — | — |
| 3 | PETI-10 | 1.0 | 230 | 63 | 100 | 15 | — | — | — | — | — | — |
| 4 | PETI-12 | 1.2 | 226 | 65 | 100 | 15 | — | — | — | — | — | — |
| 5 | PETI-12 | 1.4 | 226 | 70 | 100 | 15 | — | — | — | — | — | — |
| 6 | PETI-12 | 0.8 | 226 | 58 | 100 | 15 | — | — | — | — | — | — |
| 7 | PETI-12 | 0.8 | 226 | 68 | 2 | 15 | PETI-15 | 0.8 | 220 | 130 | 95 | 20 |
| 8 | PETI-10 | 0.8 | 230 | 49 | 1 | 3 | PETI-15 | 0.8 | 220 | 130 | 95 | 30 |
| 9 | PETI-5 | 0.8 | 240 | 14 | 1 | 3 | PETI-12 | 0.8 | 226 | 68 | 94 | 12 |
| 10 | PETI-5 | 0.8 | 240 | 14 | 0 | 1 | PETI-12 | 0.8 | 226 | 58 | 90 | 48 |
| 11 | PETI-5 | 0.8 | 240 | 14 | 0 | 1 | PETI-12 | 0.8 | 226 | 55 | 100 | 10 |
| 12 | PETI-5 | 0.8 | 240 | 14 | 0 | 1 | PETI-12 | 0.8 | 226 | 58 | 85 | 10 |
| 13 | PETI-5 | 1.0 | 240 | 27 | 0 | 2 | PETI-5 | 1.0 | 240 | 27 | 100 | 12 |
| 14 | PETI-5 | 1.0 | 240 | 27 | 0 | 2 | PETI-5 | 1.0 | 240 | 27 | 100 | 15 |
| 15 | PETI-5 | 1.0 | 240 | 27 | 0 | 2 | PETI-5 | 1.0 | 240 | 27 | 100 | 15 |
| 16 | PETI-10 | 1.0 | 230 | 63 | 0 | 2 | PETI-5 | 1.0 | 240 | 27 | 100 | 12 |
| 17 | PETI-5 | 0.8 | 240 | 14 | 0 | 3 | PETI-12 | 0.8 | 236 | 58 | 100 | 12 |
| 18 | PETI-5 | 1.0 | 240 | 14 | 0 | 1 | PETI-12 | 0.8 | 236 | 58 | 90 | 48 |

| | Polyester Resin at the Outside of the Can | | | | | | | |
|---|---|---|---|---|---|---|---|---|
| | Lower Layer | | | | | | | |
| | Composition | | | Half | | | | |
| | (mole % of | | Melting | Crystallization | TiO₂/ | | TiO₂/ | |
| Sample | isophthalic | Intrinsic | temperature | Time | Layer | Thickness | Layer | |
| No | acid) | Viscosity | (° C.) | (sec.) | (%) | (μm) | (%) | Classification |
| 1 | — | — | — | — | — | — | 12 | Comparative Example |
| 2 | — | — | — | — | — | — | 15 | Present Invention |
| 3 | — | — | — | — | — | — | 20 | Present Invention |
| 4 | — | — | — | — | — | — | 30 | Present Invention |
| 5 | — | — | — | — | — | — | 40 | Present Invention |
| 6 | — | — | — | — | — | — | 45 | Comparative Example |
| 7 | PETI-25 | 1.0 | — | Amorphous | 3 | 15 | 35 | Present Invention |
| 8 | PETI-20 | 1.0 | 211 | 182 | 4 | 2 | 35 | Present Invention |
| 9 | PETI-15 | 1.0 | 220 | 138 | 5 | 3 | 35 | Present Invention |
| 10 | PETI-12 | 1.0 | 236 | 65 | 10 | 1 | 35 | Present Invention |
| 11 | PETI-12 | 1.0 | 226 | 55 | 0 | 1 | 35 | Present Invention |
| 12 | PETI-12 | 1.0 | 226 | 65 | 15 | 1 | 35 | Comparative Example |
| 13 | PETI-10 | 1.0 | 230 | 58 | 0 | 2 | 35 | Present Invention |
| 14 | PETI-15 | 1.0 | 220 | 138 | 0 | 2 | 35 | Present Invention |
| 15 | PETI-15 | 1.0 | 220 | 138 | 0 | 2 | 35 | Present Invention |
| 16 | PETI-15 | 1.0 | 220 | 138 | 0 | 2 | 35 | Present Invention |
| 17 | PETI-10 | 0.8 | 220 | 70 | 0 | 2 | 35 | Present Invention |
| | (67 W %) | | (after blended) | | | | | |
| | PETI-25 | 1.0 | | | | | | |
| | (33 W %) | | | | | | | |
| 18 | PETI-12 | 1.0 | 226 | 65 | 10 | 1 | 35 | Comparative Example |

As the metal plate, 3 kinds of long-sheet metal plates applied by surface treatment described below were prepared.

1) TFS

Plate Thickness: 0.18 mm

Plate Width: 800 mm

Metal Chromium Amount: 150 mg/m²

Hydrous Chromium Oxide Amount: (in term of chromium) 18 mg/m²

2) Tinned Steel Plate

Plate Thickness: 0.18 mm

Plate Width: 800 mm

Tin Plating Amount: 0.2 mg/m²

Hydrous Chromium Oxide Amount: (in term of chromium) 7 mg/m²

3) Aluminum Alloy Plate (JIS 5052H39)

Thickness: 0.26 mm

Plate Width: 800 mm

Coating Amount: (in terms of phosphorous) 9 mg/m² (in terms of chromium) 8 mg/m²

On the one side and other side of any of the metal plates described above, non-oriented films employing any of the polyester resins exhibited in the Table 1 and any of the white resin exhibited in the Table 2 were laminated by a known lamination device. The temperature of the metal plate just before contacting a pair of lamination rolls was set about 30° C. higher than the Tm of the polyester in the case of TFS or the aluminum alloy plate, or set at 200° C. in the case of the tinned steel plate. When being laminated on the tinned steel plate, the non-oriented films of the polyester resin and the white resin were respectively coated with a epoxy/phenol adhesive in 1.0 μm thickness on the one side of each film and then heated to solidify before lamination, followed by lamination by subjecting the coated face to contact with tinned steel plate face. Lamination was carried out in the laminating rate of 150 m/minute, followed by immediate quenching in water to prevent crystallization and then drying.

Thus, the metal plate coated with polyester resin laminated with the polyester resin on the one side thereof and with the white resin on the other side thereof was produced. The metal plate coated with polyester resin obtained by the way described above was molded to a cylindrical can having a bottom by means of the wall-thinning deep drawing method described below.

The metal plate coated with polyester resin was punched out to a blank having diameter of 160 mm, followed by setting the surface coated by the white resin to be an outside of a can and then processing to form a drawn can having bottom of 100 mm diameter. Then, the can was again subjected to the drawing molding to form a redrawn can having bottom of 80 mm diameter. The redrawn can was further subjected to a complex molding for simultaneously stretching and ironing to form a drawn ironed can having bottom of 65 mm diameter. This complex molding was carried out in the following conditions; the distance between the redrawn part, which was to be a top end of the can, and the ironed part was 20 mm, the radius at shoulder of a redrawing dice was 1.5 times of the plate thickness, the clearance between redrawing dice and punch was 1.0 times of the plate thickness, and the clearance at ironing molding part was 50% of the original plate thickness. Thereafter, the can top end was trimmed by a known art and subjected to a neck-in processing and flange processing.

The evaluation methods for the polyester resin and the metal plate coated with polyester resin are explained below.

(Thickness of Rein Layer)

A non-oriented film was embedded in an epoxy embedding resin, followed by slicing in 5 μm thickness to measure by observing the sliced section with a microscope.

(Intrinsic Viscosity (IV Value))

The polyester resin was dissolved in a mixture of phenol/tetrachroroethane solution mixed in 1:1 ratio, followed by measurement of specific viscosity with a Ubellohde's viscometer in a constant temperature bath of 30° C. to obtain intrinsic viscosity value.

(Moldability)

The can molded by the wall-thinning deep drawing method was observed by eyes, followed by evaluation according to the following evaluation bases.

⊙: No fine crack and cut down the film was observed.

◯: Slight cracks which is not harmful for practical use was observed.

Δ: Cracks and cut down the film which are harmful for practical use were observed.

x: Shell should be broken in the molding processing.

(Corrosion Resistance)

The top end of the can molded with the wall-thinning deep drawing method was trimmed and then subjected to the neck-in processing and flange processing. The processed can was filled with water and sealed by fastening with a lid made of the same metal plate coated with polyester resin employed to the can, followed by pasteurization at 130° C. for 30 minutes, and then was held at 37° C. for 1 month. The can was opened after 1 month elapsed to observe occurrence of stain in the can by eyes, followed by evaluating moldability according to the following evaluation bases.

⊙: No stain was observed.

◯: Slight stain which is not harmful for practical use was observed.

Δ: Stain which is harmful for practical use was observed.

x: Significant amount of stain was observed on the surface.

(Ability of Hiding Substrate)

The color tone (whiteness) of the outside of the can shell molded by the wall-thinning deep drawing method and the color tone (whiteness) of the non-oriented film of polyester containing titanium dioxide of 40% by weight are compared by eyes, followed by evaluating the ability to hide substrate metal of the outside of the can shell according to the following evaluation bases.

⊙: Color tone almost same to that of the resin film was exhibited.

◯: Slight color tone difference (decrease of whiteness) which is not harmful for practical use was observed.

Δ: Color tone difference (decrease of whiteness) which is harmful for practical use was observed.

x: Significant color tone difference (decrease of whiteness) was observed.

(Preservation of Flavoring Properties)

The top end of the can molded with the wall-thinning deep drawing method was trimmed and then subjected to the neck-in processing and flange processing. The processed can was filled with coffee beverage and sealed by fastening with a lid made of the same metal plate coated with polyester resin employed to the can, followed by pasteurization in heated steam (130° C.) for 30 minutes, and then was held at 37° C. for 3 weeks. The can was opened after the weeks passed, and then fifty panelists investigated the change of flavor of content before and after the elapse of the time. The preservation of flavoring properties was evaluated based on the number of panelists who found no difference in flavor before and after the elapse of the time.

⊙: ≧40

◯: ≧35

Δ: <35, ≧30

x: <30

The evaluation results were exhibited in Table 3.

TABLE 3
Evaluation result

| | Result of Characteristics Evaluation | | | | |
|---|---|---|---|---|---|
| | | | Ability of | | |
| Sample | | Corrosion | Hiding | Flavoring | |
| No | Moldability | Resistance | Substrate | Properties | Classification |
| 1 | Δ | X | Δ | ◯ | Comparative Example |
| 2 | ◯ | ◯ | ◯ | ◯ | Present Invention |
| 3 | ⊚ | ◯ | ◯ | ◯ | Present Invention |
| 4 | ⊚ | ◯ | ⊚ | ⊚ | Present Invention |
| 5 | ⊚ | ◯ | ⊚ | ⊚ | Present Invention |
| 6 | X | no evaluation | no evaluation | no evaluation | Comparative Example |
| 7 | ◯ | ⊚ | ⊚ | ◯ | Present Invention |
| 8 | ◯ | ⊚ | ⊚ | ◯ | Present Invention |
| 9 | ⊚ | ⊚ | ⊚ | ◯ | Present Invention |
| 10 | ⊚ | ◯ | ⊚ | ⊚ | Present Invention |
| 11 | ◯ | ◯ | ⊚ | ⊚ | Present Invention |
| 12 | Δ | ◯ | ⊚ | ⊚ | Comparative Example |
| 13 | ⊚ | ⊚ | ⊚ | ◯ | Present Invention |
| 14 | ⊚ | ⊚ | ⊚ | ⊚ | Present Invention |
| 15 | ⊚ | ⊚ | ⊚ | ⊚ | Present Invention |
| 16 | ⊚ | ⊚ | ⊚ | ◯ | Present Invention |
| 17 | ⊚ | ⊚ | ⊚ | ◯ | Present Invention |
| 18 | X | no evaluation | no evaluation | no evaluation | Comparative Example |

As shown in Table 3, any of the metal plates coated with polyester resin of the present invention are excellent in moldability and exhibit well corrosion resistance, color tone and preservation of flavoring properties; furthermore, the metal plate of which side to be inside of a can is coated with the two-layer, resin wherein the melting temperature of the polyester resin of the upper layer is higher than that of the polyester resin of the lower layer, and the metal plate of which side to be outside of a can is coated with the three-layer resin wherein the upper layer and the core layer have higher melting temperature than the melting temperature of the polyester resin of the lower layer and the amount of the white pigment contained in the upper layer and the lower layer is lower than that in the core layer, is more excellent in moldability, color tone, corrosion resistance and preservation of flavoring properties.

### INDUSTRIAL APPLICABILITY

The present invention is a metal plate in which the metal plate is coated with a polyester resin having an intrinsic viscosity of 0.6 to 1.4, and the metal plate side to be inside of a can is coated with a two-layer resin wherein the melting temperature of the polyester resin of the upper layer is higher than that of the polyester resin of the lower layer, and the side to be outside of a can is coated with a three-layer resin wherein the upper layer and the core layer have higher melting temperature than the melting temperature of the polyester resin of the lower layer and the amount of the white pigment contained in the upper layer and the lower layer is lower than that in the core layer; and the metal plate of the invention does not generate cracks and fractures in the resin when being applied by a severe molding processing such as wall-thinning deep drawing, and exhibits excellent moldability and corrosion resistance. A can employing the metal plate coated with polyester resin of the present invention is excellent in preservation of flavoring properties for content.

1. A metal plate, wherein the surface roughness Ra (JIS B 0601) is 1 μm or less, coated with polyester resin comprising a metal plate and a coating coated on both sides of the metal plate with a non-oriented polyester resin having an intrinsic viscosity of 0.6 to 1.4.

2. The metal plate coated with polyester resin according to claim 1, wherein the metal plate is coated on at least one side thereof with a transparent polyester resin without containing a pigment.

3. The metal plate coated with polyester resin according to claim 2, wherein the transparent polyester resin comprises a two-layer resin of a lower resin layer contacting the metal plate and a upper resin layer coated on the lower layer, wherein a melting temperature of the upper layer resin is higher than a melting temperature of the lower layer resin.

4. The metal plate coated with polyester resin according to claim 1, wherein the metal plate is coated on at least one side thereof with a colored polyester resin containing a pigment.

5. The metal plate coated with polyester resin according to claim 4, wherein the colored polyester resin contains a pigment of 15 to 40% by weight.

6. The metal plate coated with polyester resin according to claim 4, wherein the colored polyester resin comprises a three-layer resin of a lower resin layer contacting the metal plate, a core resin layer coated thereon and a upper resin layer further coated thereon, wherein each of melting temperatures of the upper layer resin and the core layer resin is higher than a melting temperature of lower layer resin.

7. The metal plate coated with polyester resin according to claim 6, wherein the core layer in the three-layer resin has 90 to 100% of an amount of the pigment contained in whole of the three-layer resin.

8. The metal plate coated with polyester resin according to claim 4, wherein the pigment is a titanium dioxide.

9. The metal plate coated with polyester resin according to claim 1, wherein the metal plate is any of a tinned steel plate, a tin-free steel plate or an aluminum alloy plate.

10. A can using the metal plate coated with polyester resin according to claim 1.

11. The metal plate coated with polyester resin according to claim 5, wherein the colored polyester resin comprises a three-layer resin of a lower resin layer contacting the metal plate, a core resin layer coated thereon and a upper resin layer further coated thereon, wherein each of melting temperatures of the upper layer resin and the core layer resin is higher than a melting temperature of lower layer resin.

12. The metal plate coated with polyester resin according to claim 11, wherein the core layer in the three-layer resin has 90 to 100% of an amount of the pigment contained in whole of the three-layer resin.

13. The metal plate coated with polyester resin according to claim 12, wherein the pigment is a titanium dioxide.

14. The metal plate coated with polyester resin according to claim 7, wherein the pigment is a titanium dioxide.

15. A can using the metal plate coated with polyester resin according to claim 3.

16. A can using the metal plate coated with polyester resin according to claim 7.

17. A can using the metal plate coated with polyester resin according to claim 13.
